(19) United States
(12) Patent Application Publication
(10) Pub. No.: US 2007/0297015 A1
(43) Pub. Date: Dec. 27, 2007

(54) Image forming apparatus, warm-up method thereof and image forming method

(75) Inventor: Satoshi Kinouchi, Shinjuku-ku (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: Kabushiki Kaisha Toshiba, Minato-ku (JP); Toshiba Tec Kabushiki Kaisha, Shinagawa-ku (JP)

(21) Appl. No.: 11/474,188

(22) Filed: Jun. 23, 2006

(51) Int. Cl. H04N 1/29

(52) U.S. Cl. 358/300

(57) ABSTRACT

In the invention, a fixing unit of an image forming apparatus having plural image forming units, which can be driven simultaneously, is warmed up according to a state of a request for a print job of the image forming apparatus to reduce warm-up time. After the warm-up is completed, supply of electric power to the fixing unit in a ready state is controlled according to a state of a request for a print job. Energy saving is realized without spoiling convenience of use for a user.

### FIELD OF THE INVENTION

The present invention relates to an image forming apparatus that has plural image forming units, which can be driven simultaneously, a warm-up method thereof, and an image forming method.

### DESCRIPTION OF THE RELATED ART

In recent years, an increase in process speed and diversification of functions are desired in image forming apparatuses that form images on recording media. To realize the increase in process speed and the diversification of functions, conventionally, there is an apparatus including plural image forming functions in the identical apparatus. For example, JP-A-8-156338 and JP-A-8-248808 disclose image forming apparatuses that have electrophotographic image forming means and ink jet image forming means in combination.

However, all of these conventional image forming apparatuses form images with the ink jet image forming means after fixing images, which are formed by the electrophotographic image forming means, on recording materials with a fixing roller. The image forming apparatuses do not have a fixing function (a drying function) for images formed by the ink jet image forming means. Therefore, it is likely that drying of ink images formed on recording materials by the ink jet image forming means is delayed to hinder an increase in speed of an image formation process.

Moreover, all the conventional image forming apparatuses do not include plural electrophotographic image forming means and plural fixing rollers in the identical apparatuses. Therefore, control of the fixing rollers for fixing images, which are formed by the plural electrophotographic image forming means, on recording materials with the respective fixing rollers is not taken into account. In other words, a reduction in standby time for warm-up of the plural fixing rollers or optimization of power consumption of the plural fixing rollers is not taken into account. Therefore, it is likely that convenience for users or energy saving is spoiled.

Thus, development of an image forming apparatus including plural image forming functions in the identical apparatus is desired. The image forming apparatus can control warm-up of a fixing device according to a requested job or control heating temperature or applied pressure of the fixing device to realize an increase in speed of process speed, realize convenience of use, and realize energy saving.

### SUMMARY OF THE INVENTION

In an aspect of the invention, an image forming apparatus including plural image forming functions in the identical apparatus is obtained. The image forming apparatus is a high-performance image forming apparatus that realizes an increase in speed of process speed including a reduction in warm-up without spoiling energy saving.

According to an embodiment of the invention, the image forming apparatus is characterized by including plural image forming units that are built in the same housing and can be driven simultaneously, at least one of which includes an electrophotographic system, plural fixing units that fix images formed by the image forming units on recording media, and a control unit that variably controls warm-up operations for the plural fixing units in accordance with driving operations for the plural image forming units.

### BRIEF DESCRIPTION OF THE DRAWINGS

FIG. 1 is a schematic diagram showing an image forming apparatus according to a first embodiment of the invention;

FIG. 2 is a schematic diagram showing a first fixing device according to the first embodiment of the invention;

FIG. 3 is a block diagram showing a control system of a fixing device according to the first embodiment of the invention;

FIG. 4 is a flowchart for explaining warm-up according to the first embodiment of the invention;

FIG. 5 is a flowchart for explaining ready time according to the first embodiment of the invention;

FIG. 6 is a schematic diagram showing an image forming apparatus according to a second embodiment of the invention;

FIG. 7 is a schematic diagram showing a first fixing device according to the second embodiment of the invention;

FIG. 8 is a block diagram showing a control system of a fixing device according to the second embodiment of the invention;

FIG. 9 is a flowchart for explaining warm-up and ready time according to the second embodiment of the invention;

FIG. 10 is a flowchart for explaining ready time according to the second embodiment of the invention;

FIG. 11A is a schematic diagram showing an image forming apparatus according to a third embodiment of the invention;

FIG. 11B is a schematic diagram showing an example of a modification of a third embodiment of the invention;

FIG. 12 is a schematic diagram showing a third fixing device according to the third embodiment of the invention;

FIG. 13 is a block diagram showing a control system of a fixing device according to the third embodiment of the invention;

FIG. 14 is a flowchart for explaining warm-up according to the third embodiment of the invention; and

FIG. 15 is a flowchart for explaining ready time according to the third embodiment of the invention.

### DETAILED DESCRIPTION OF THE INVENTION

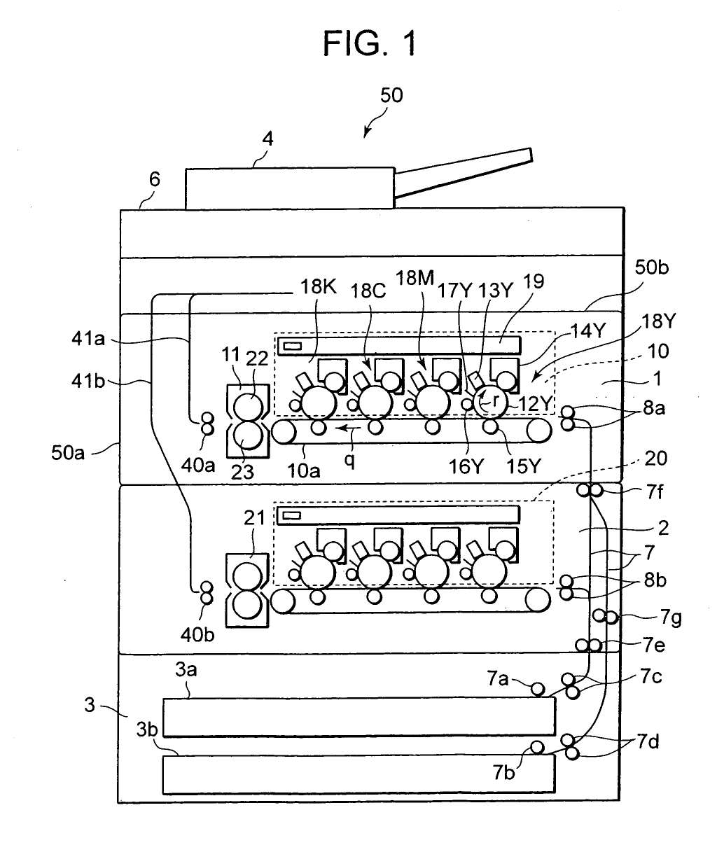

A first embodiment of the invention will be hereinafter explained in detail with the accompanying drawings as an example. FIG. 1 is a schematic diagram showing an image forming apparatus 50 according to an embodiment of the invention. The image forming apparatus 50 includes a first image forming unit 1 and a second image forming unit 2 in a main body 50a, which is an identical housing. The image forming apparatus 50 includes, on an upper surface thereof, a scanner unit 6 that reads an original supplied by an auto document feeder 4. The image forming apparatus 50 includes a cassette mechanism 3 that supplies sheets P to the first image forming unit 1 or the second image forming unit 2.

The cassette mechanism 3 includes first and second sheet feeding cassettes 3a and 3b. In a conveyance path 7 leading from the respective sheet feeding cassettes 3a and 3b to the first image forming unit 1 or the second image forming unit 2, a pickup roller 7a that extracts a sheet from the sheet feeding cassette 3a, a separating and conveying roller 7c, conveying rollers 7e and 7f, and registration rollers 8a and 8b are provided. Moreover, in the conveyance path 7, a pickup roller 7b that extracts a sheet from the sheet feeding cassette 3b, a separating and conveying roller 7d, and a conveying roller 7g are provided.

The first image forming unit 1 has a first color image forming unit 10 serving as an image forming unit of the electrophotographic system. Moreover, the first image forming unit 1 has a first fixing device 11 serving as a fixing unit that fixes a toner image, that is, an image formed on the sheet P serving as a recording medium by the first color image forming unit 10. The second image forming unit 2 has a second color image forming unit 20 serving as an image forming unit of the electrophotographic system. Moreover, the second image forming unit 2 has a second fixing device 21 serving as a fixing unit that fixes a toner image, that is, an image formed on the sheet P serving as a recording medium by the color image forming unit 20.

The first color image forming unit 10 and the second color image forming unit 20 are detachably attachable to the main body 50a. In the image forming apparatus 50, it is possible to replace the first color image forming unit 10 or the second color image forming unit 20 with, for example, another image forming unit dedicated for a monochrome as required. Process speed of the first image forming unit 1 and the second image forming unit 2 is 25 sheets/minute. Maximum electric power usable in the first fixing device 11 or the second fixing device 21 is 1400 W. However, maximum electric power required by the first fixing device 11 and the second fixing device 21 in fixing a toner image is 700 W. Downstream from the first and the second fixing devices 11 and 21, sheet discharge rollers 40a and 40b are provided, respectively, and sheet conveyance paths 41a and 41b for conveying the sheet P after fixing to a sheet discharge unit 50b are provided.

The first image forming unit 1 has a transfer belt 10a rotated in an arrow q direction. Image forming stations 18Y, 18M, 18C, and 18K of respective colors of yellow (Y), magenta (M), cyan (C), and black (K) are arranged in tandem along the transfer belt 10a.

The image forming station 18Y of yellow (Y) is formed by arranging a charger 13Y serving as a process member, a developing device 14Y, a transfer roller 15Y, a cleaner 16Y, and a charge eliminator 17Y around a photosensitive drum 12Y serving as an image bearing member that rotates in an arrow r direction. A laser exposure device 19 that irradiates a laser beam on the photosensitive drum 12Y is provided above the image forming station 18Y of yellow (Y).

The image forming stations 18M, 18C, and 18K of the respective colors of magenta (M), cyan (C), and black (K) have the same structure as the image forming station 18Y of yellow (Y).

In the image forming station 18Y of yellow (Y), the photosensitive drum 12Y and the charger 13Y, the developing device 14Y, the cleaner 16Y, and the charge eliminator 17Y around the photosensitive drum 12Y constitute a process cartridge and are integrally detachably attachable to the main body 50a. A structure of the process cartridge is not limited. The process cartridge only has to integrally support at least any one of a charger, a developing device, and a cleaner and a photosensitive drum and be detachably attachable to an image forming apparatus main body. A structure of the process cartridge is arbitrary, for example, only the developing device and the cleaner around the photosensitive drum are integrally detachably attachable to the image forming apparatus main body as an integrated process cartridge.

In the first image forming unit 1, according to start of print operation, in the image forming station 18Y of yellow (Y), the photosensitive drum 12Y rotates in the arrow r direction and is uniformly charged by the charger 13Y. Subsequently, exposing light corresponding to image information read by the scanner unit 6 is irradiated on the photosensitive drum 12Y by the laser exposure device 19 and an electrostatic latent image is formed on the photosensitive drum 12Y. Thereafter, a toner image is formed on the photosensitive drum 12Y by the developing device 14Y. In the position of the transfer roller 15Y, the toner image is transferred onto the sheet P conveyed in the arrow q direction on the transfer belt 10a. After the transfer ends, a residual toner on the photosensitive drum 12Y is cleaned by the cleaner 16Y and the surface of the photosensitive drum 12Y is subjected to charge elimination by the charge eliminator 17Y to make it possible to perform the next print.

The image forming stations 18M, 18C, and 18K of the respective colors of magenta (M), cyan (C), and black (K) perform image forming operation in the same manner as the image forming station 18Y to form a full color toner image on the sheet P. Thereafter, the full color toner image on the sheet P is heated, pressed, and fixed by the first fixing device 11, whereby a print image is completed. The second image forming unit 2 has the same structure as the first image forming unit 1 and performs print operation in the same manner as the first image forming unit 1.

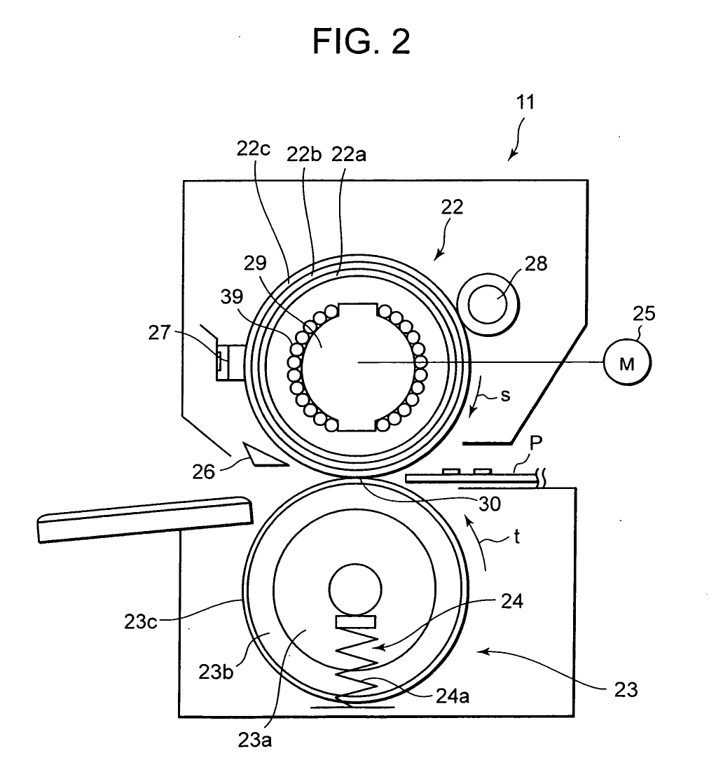

The first fixing device 11 will be described. FIG. 2 is a schematic diagram showing a first fixing device 11. The first fixing device 11 has a heat roller 22 and a press roller 23. The heat roller 22 is driven in an arrow s direction by a driving motor 25. The press roller 23 is brought into press contact with the heat roller 22 by a pressing mechanism 24 having a compression spring 24a. The press roller 23 rotates in an arrow t direction following the heat roller 22. The heat roller 22 has, for example, a solid rubber layer 22b and a release layer 22c around a core metal 22a and a diameter thereof is set to 40 mm. Thickness of the core metal 22a is set to 2 mm, thickness of the solid rubber layer 22b is set to 2 mm, and thickness of the release layer 22c is set to 50 μm. As a material of the core metal 22a, iron is used.

An induction heating device 29 is arranged inside the core metal 22a. The induction heating device 29 has an induction heating coil 39. When a high-frequency current is supplied to the induction heating coil 39 by an inverter circuit 34, a magnetic field is generated. The induction heating device 29 generates an eddy current in the core metal 22a with this magnetic field to heat the core metal 22a. It is possible to change a heating output of the inverter circuit 34 from 100 W to 1500 W by varying a driving frequency.

The press roller 23 has a silicon rubber layer 23b and a release layer 23c made of fluororubber around a core metal 23a and a diameter thereof is set to 40 mm. When the press roller 23 is pressed and brought into contact with the heat roller 22 by the pressing mechanism 24, the surface of the heat roller 22 is elastically deformed. Consequently, a nip 30 having a fixed contact width with respect to the conveying direction of the sheet P is formed between the heat roller 22 and the press roller 23. When the sheet P passes the nip 30, the toner image on the sheet P is heated, pressed, and fixed.

A peeling pawl 26 that prevents twining of the sheet P, a temperature sensor 27 that detects surface temperature of the heat roller 22, and a cleaning roller 28 that applies a releasing agent for preventing offset are provided around the heat roller 22. The second fixing device 21 has the same structure as the first fixing device 11.

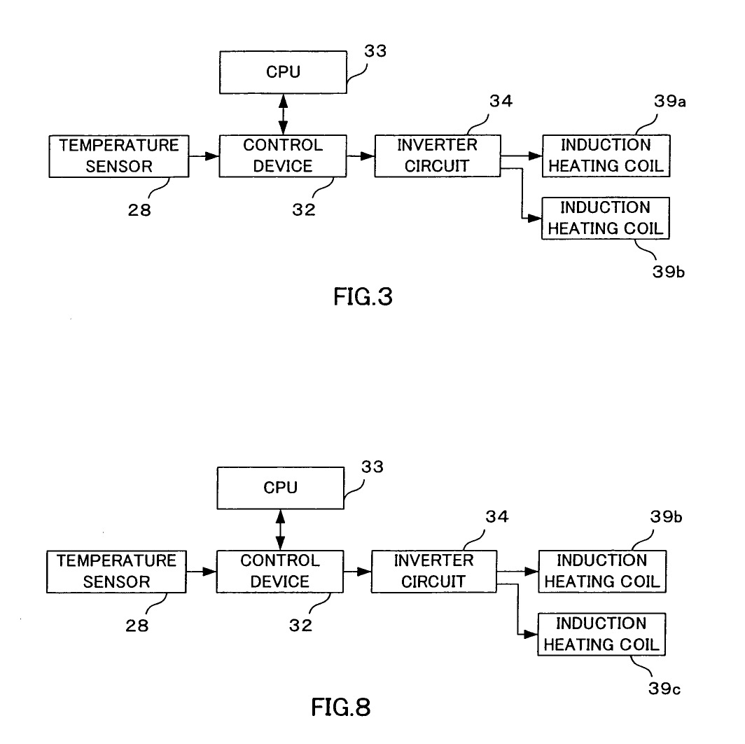

A control system for the first and the second fixing devices 11 and 21 is shown in FIG. 3. A control device 32, which is a control unit that controls the first and the second fixing devices 11 and 21, is connected to a CPU 50 that controls the image forming apparatus 50. A detection result from the temperature sensor 28 is inputted to an input side of the control device 32. An inverter circuit 34 that supplies a high-frequency current to an induction heating coil 39a of the induction heating device 29 of the first fixing device 11 and an induction heating coil 39b of the induction heating device 29 of the second fixing device 21 is connected to an output side of the control device 32.

The control device 32 controls the inverter circuit 34 according to various driving operations for the first image forming unit 1 or the second image forming unit 2 of the image forming apparatus 50 inputted from the CPU 33. The control device 32 controls the inverter circuit 34 while controlling the temperature of the heat roller 22 on the basis of a detection result of the temperature sensor 28. The control device 32 controls the inverter circuit 34 to thereby control warm-up of the first fixing device 11 or the second fixing device 21. Moreover, the control device 32 controls pre-heating at ready time after the warm-up ends.

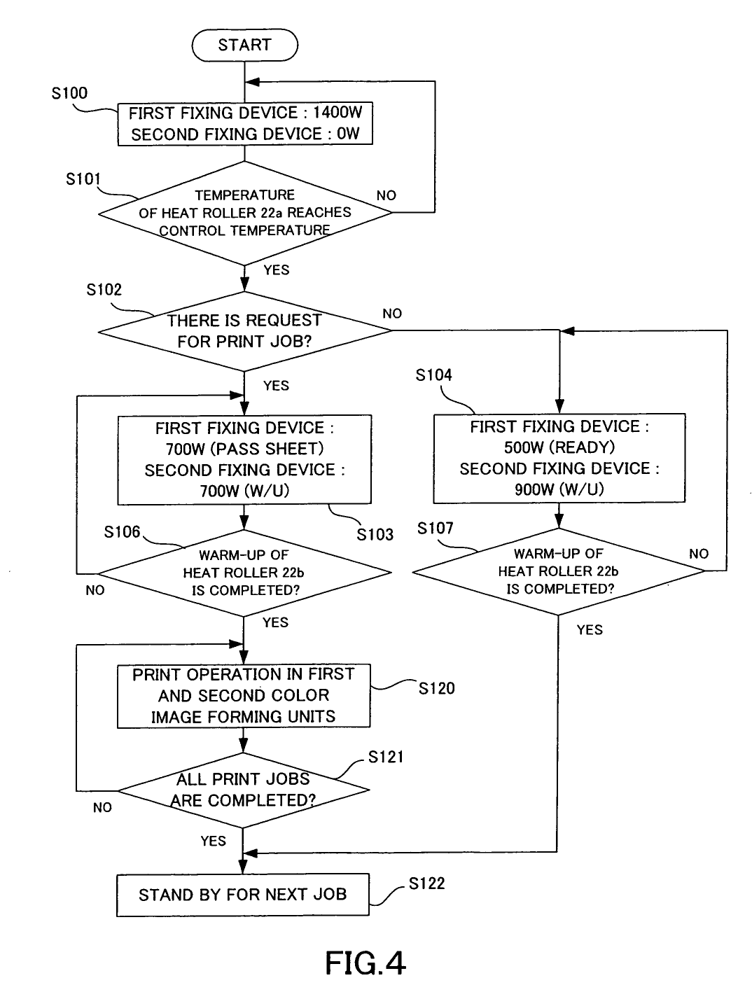

Actions will be described. When a power supply of the image forming apparatus 50 is turned on, the control device 32 controls warm-up of the first fixing device 11 and the second fixing device 21 in accordance with a flowchart of warm-up shown in FIG. 4. Since no image forming operation is performed at the time of warm-up, in the image forming apparatus 50, it is possible to use maximum electric power of 1400 W in the first fixing device 11 and the second fixing device 21.

In order to minimize waiting time for a print job, first, for example, the first fixing device 11 is warmed up. The control device 32 controls the inverter circuit 34 to supply electric power of 1400 W to the first fixing device 11 and setting electric power supplied to the second fixing device 21 to 0 W (step 100). Electric power of 1400 W may be supplied to the second fixing device 21 and electric power supplied to the first fixing device 11 may be set to 0 W. When the temperature of the heat roller 22a of the first fixing device 11 reaches, for example, 160° C., the control device 32 completes the warm-up (step 101).

At this point, since electric power as large as 1400 W is supplied to the first fixing device 11, warm-up time is reduced to about 80 sec. On the other hand, for example, at the time of warm-up of the image forming apparatus 50, when electric power of 700 W is supplied to each of the first fixing device 11 and the second fixing device 21, about 180 sec is required as warm-up time for the first fixing device 11 and the second fixing device 21.

Subsequently, the control device 32 judges whether there is a request for a print job in the first image forming unit 1 (step 102). If there is a request for a print job, the control device 32 proceeds to step 103. If there is no request for a print job, the control device 32 proceeds to step 104.

In step 103, the control device 32 carries out print operation in the first color image forming unit 10. Subsequently, in the first fixing device 11, the control device 32 heats, presses, and fixes the color toner image formed on the sheet P by the first color image forming unit 10. At this point, the control device 32 controls the inverter circuit 34 to supply electric power of 700 W to the first fixing device 11 in order to fix the color toner image. At the same time, the control device 32 controls the inverter circuit 34 to supply electric power of 700 W to the second fixing device 21 in order to warm up the second fixing device 21.

In step 106, when the temperature of the heat roller 22b of the second fixing device 21 reaches, for example, 160° C. and the control device 32 completes the warm-up, the control device 32 proceeds to step 120. The control device 32 performs print operation in both the first color image forming unit 1 and the second color image forming unit 2 to process the print job at high speed. When the control device 3.2 completes all print jobs in step 121, the control device 32 stands by for the next print job (step 122).

On the other hand, in step 104, the control device 32 controls the inverter circuit 34 to supply electric power of 500 W to the first fixing device 11 in order to preheat the first fixing device 11 that has been warmed up and is in a ready state. At the same time, the control device 32 controls the inverter circuit 34 to supply electric power of 900 W to the second fixing device 21 in order to warm up the second fixing device 21. When the heat roller 22b of the second fixing device 21 completes the warm-up in step 107, the control device 32 proceeds to step 122 and stands by for a request for a print job.

Compared with electric power of 700 W supplied to the second fixing device 21 in step 103 in which a print job is requested, in the case of step 104 in which a print job is not requested, it is possible to increase electric power supplied to the second fixing device 21 to 900 W. As a result, it is possible to complete warm-up for the second fixing device 21 in a shorter time. It is also possible to use the warm-up operation for the first fixing device 11 and the second fixing device 21 according to the flowchart in FIG. 4 in control of the first fixing device 11 and the second fixing device 21 in, for example, restoring the image forming apparatus 50 from an off mode.

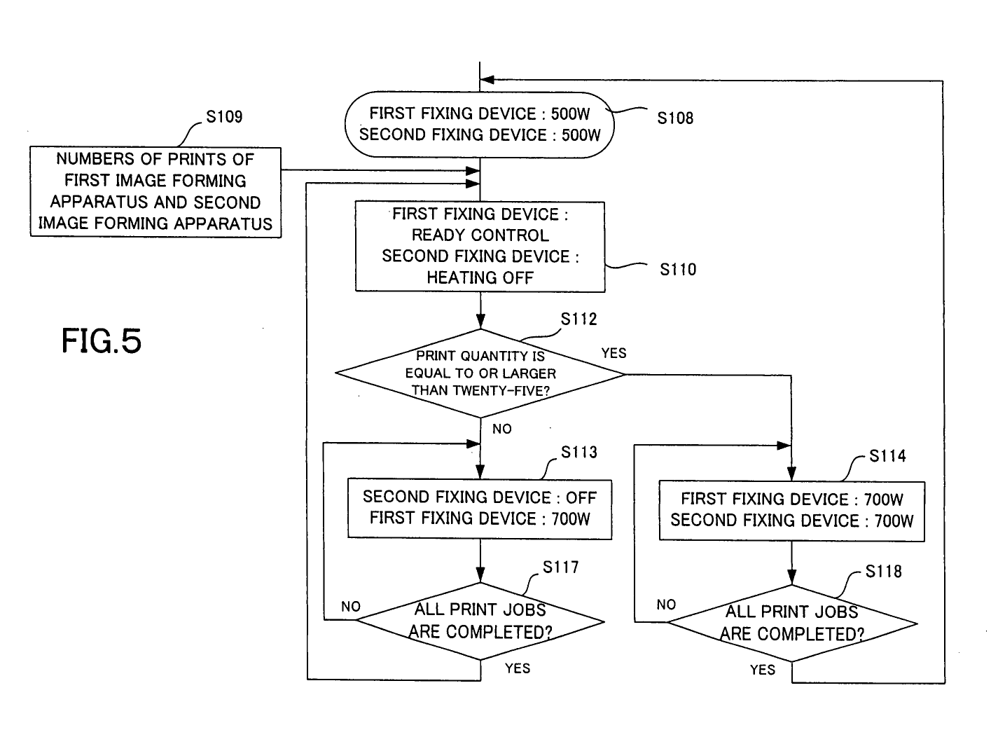

Control during standby for a print job after the warm-up of the first fixing device 11 and the second fixing device 21 is completed will be described. When the warm-up of both the first fixing device 11 and the second fixing device 21 is completed, the first fixing device 11 and the second fixing device 21 are controlled in accordance with a flowchart shown in FIG. 5. When the warm-up of both the first fixing device 11 and the second fixing device 21 is completed and the first fixing device 11 and the second fixing device 21 come into a ready state, the control device 32 controls the inverter circuit 34 to supply, for preheat, electric power of 500 W to each of the first fixing device 11 and the second fixing device 21 (step 108).

Thereafter, when there is no request for a print job for a fixed time, the control device 32 turns off the fixing device of the first image forming unit 1 or the second image forming unit 2 (step 110). In this way, energy saving during standby for a print job is realized. Selection of the first fixing device 11 or the second fixing device 21 to be turned off in step 110 is judged from information on the first image forming unit 1 and the second image forming unit 2 inputted from the CPU 33 to the control device 32. The information inputted from the CPU 33 is, as indicated in step 109, for example, information on a state of use such as a total number of prints of the first image forming unit 1 and the second image forming unit 2.

According to the information from the CPU 33, the control device 32 can recognize time of replacement of consumables (the photosensitive drum 12, the heat roller 22, the press roller 23, etc.) of the first image forming unit 1 and the second image forming unit 2. Therefore, the control device 32 determines which of the fixing devices 11 and 21 is turned off such that the time of replacement of consumables is staggered in the first image forming unit 1 and the second image forming unit 2. At the time of start of warm-up in step 100, the control device 32 may judge, according to the information from the CPU 33, which of the first fixing device 11 and the second fixing device 21 should be started.

For example, after the first fixing device 11 is held in the ready state and, on the other hand, the second fixing device 21 is brought into the off state in step 110, when a request for a print job is inputted, the control device 32 judges whether the second fixing device 21 should be turned on (step 112). For example, if a print quantity of the print job is less than twenty-five, the control device 32 proceeds to step 113. If a print quantity is equal to or larger than twenty-five, the control device 32 proceeds to step 114.

In step 113, the control device 32 processes the print job using only the first image forming unit 1 while keeping the second fixing device 21 off. The control device 32 controls the inverter circuit 34 to increase electric power supply to the first fixing device 11 from a preheat state of 500 W to a fixable state of 700 W and keep electric power supply to the second fixing device 21 at 0 W in order to fix the color toner image. Consequently, the user does not feel the stress due to long print time and it is possible to maintain energy saving. When all print jobs are completed, the control device 32 returns to step 110.

On the other hand, in step 114, the control device 32 uses both the first image forming unit 1 and the second image forming unit 2 to turn on the second fixing device 21 in order to process print jobs in parallel. The control device 32 controls the inverter circuit 34 to supply electric power of 700 W to the first fixing device 11 in order to fix the color toner image and, on the other hand, supply electric power of 700 W to the second fixing device 21 in order to warm up the second fixing device 21.

Until the warm-up for the second fixing device 21 is completed, the control device 32 processes the print jobs only with the first image forming unit 1. When the warm-up for the second fixing device 21 is completed, the control device 32 processes the print jobs using both the first image forming unit 1 and the second image forming unit 2 simultaneously. Consequently, print processing time is reduced. The user does not feel the stress of being kept waiting for print at the beginning of a print job. When the control device 32 completes step 114, the control device 32 returns to step 108.

According to this embodiment, the first image forming unit 1 and the second image forming unit 2 are set in parallel in the image forming apparatus 50 and, in processing print jobs using the first image forming unit land the second image forming unit 2, at the time of warm-up, one of the fixing devices 11 and 21 is started first to reduce time during which the user is on standby. At the time of print job processing, process speed of the jobs is increased using both first image forming unit 1 and the second image forming unit 2. Moreover, at the time of standby for a print job, one of the fixing devices 11 and 21 is turned off to realize energy saving. In other words, supply of electric power to the first and the second fixing devices 11 and 21 heated by the induction heating device 29 is controlled according to an operation state of the image forming apparatus 50. Therefore, even in the high-performance image forming apparatus 50 capable of processing a print job at high speed, it is possible to realize energy saving and improve convenience of use for the user.

A second embodiment of the invention will be explained. In the configuration of the second embodiment is the same as that of the first embodiment except that one of the two image forming units in the first embodiment is changed to a monochrome image forming unit and the other is changed to a color image forming unit. Therefore, in the second embodiment, components identical with those explained in the first embodiment are denoted by the identical reference numerals and signs. Detailed explanations of the components are omitted.

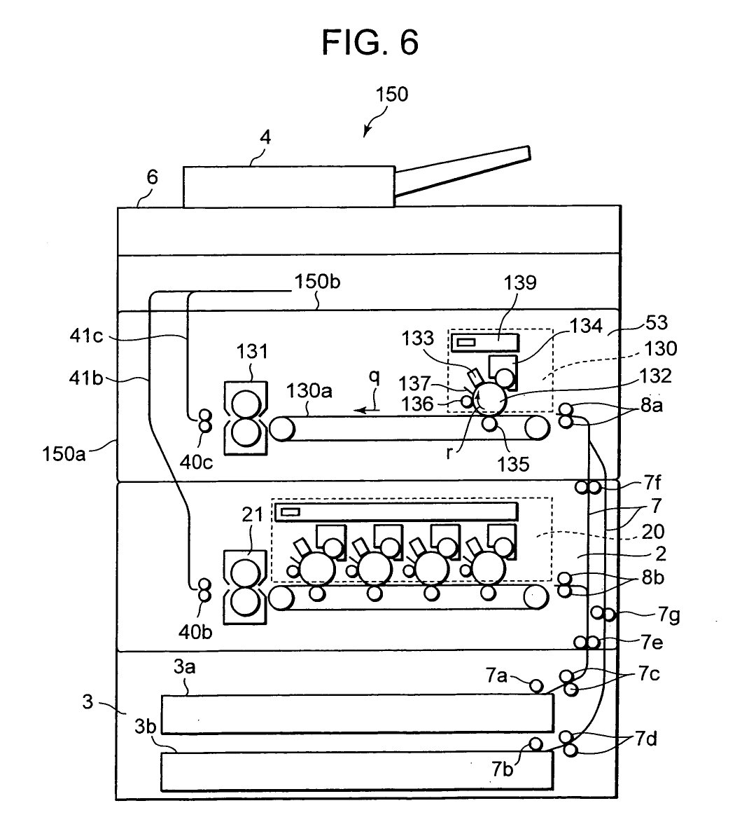

In the second embodiment, as shown in FIG. 6, a third image forming unit 53 and the second image forming unit 2 are included in a main body 150a of an image forming apparatus 150. The third image forming unit 53 has a monochrome image forming unit 130 serving as an image forming unit of the electrophotographic system, and a third fixing device 131 serving as a fixing unit that fixes a toner image formed on the sheet P. The monochrome image forming unit 130 is constituted to be detachably attachable to the main body 50a. Therefore, the image forming apparatus 150 is constituted by taking out the first color image forming unit 10 from the main body 50a of the image forming apparatus 50 in the first embodiment and attaching the monochrome image forming unit 130.

Process speed of the second image forming unit 2 is 25 sheets/minute. Process speed of the third image forming unit 53 is 45 sheets/minute. Maximum electric power usable in the third fixing device 131 is 1400 W. However, maximum electric power required by the second fixing device 21 and the third fixing device 131 at the time of fixing of a toner image is 700 W. Downstream from the third fixing device 131, a sheet discharge roller 40c is provided and a sheet discharge conveyance path 41c that conveys the sheet P after fixing to the sheet discharge unit 150b is provided.

The third image forming unit 53 has a transfer belt 130a rotated in the arrow q direction. A photosensitive drum 132 is arranged to be opposed to the transfer belt 130a. A charger 133, a developing device 134 for black (K), a transfer roller 135, a cleaner 136, and a charge eliminator 137 are arranged around the photosensitive drum 132 rotating in the arrow r direction. A laser exposure device 139 that irradiates a laser beam on the photosensitive drum 132 is provided above the photosensitive drum 132.

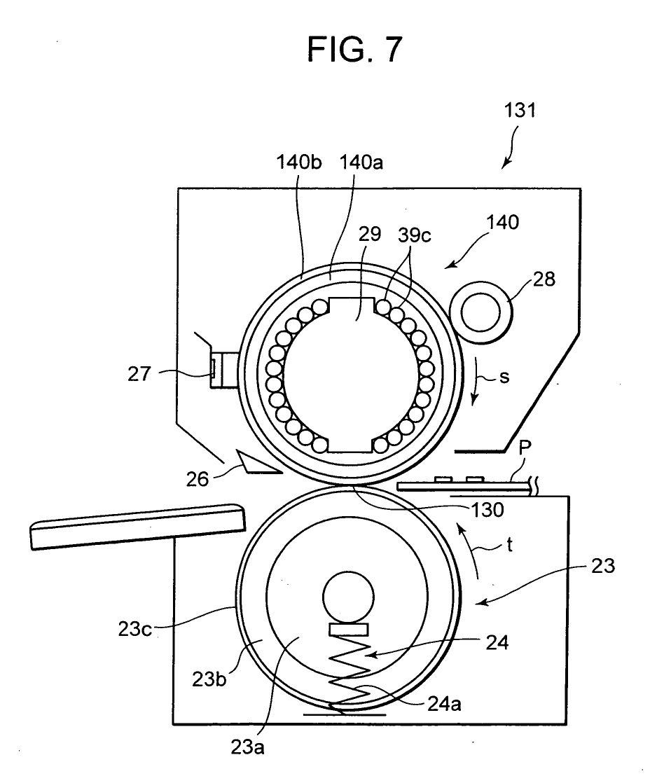

The third fixing device 131 is shown in FIG. 7. The third fixing device 131 is different from the second fixing device 21 in a structure of a heat roller 140. The heat roller 140 has, for example, a release layer 140b around a core metal 140a and a diameter thereof is set to 40 mm. Thickness of the core metal 140a is set to 1 mm and thickness of the release layer 140b is set to 30 μm. As a core metal material, iron is used. The induction heating device 29 is arranged inside the core metal 140a. The induction heating device 29 has an induction heating coil 39c. As shown in FIG. 8, the inverter circuit 34 connected to the output side of the control device 32 supplies a high-frequency current to the induction heating coil 39b of the induction heating device 29 of the second fixing device 21 and the induction heating coil 39c of the induction heating device 29 of the third fixing device 131.

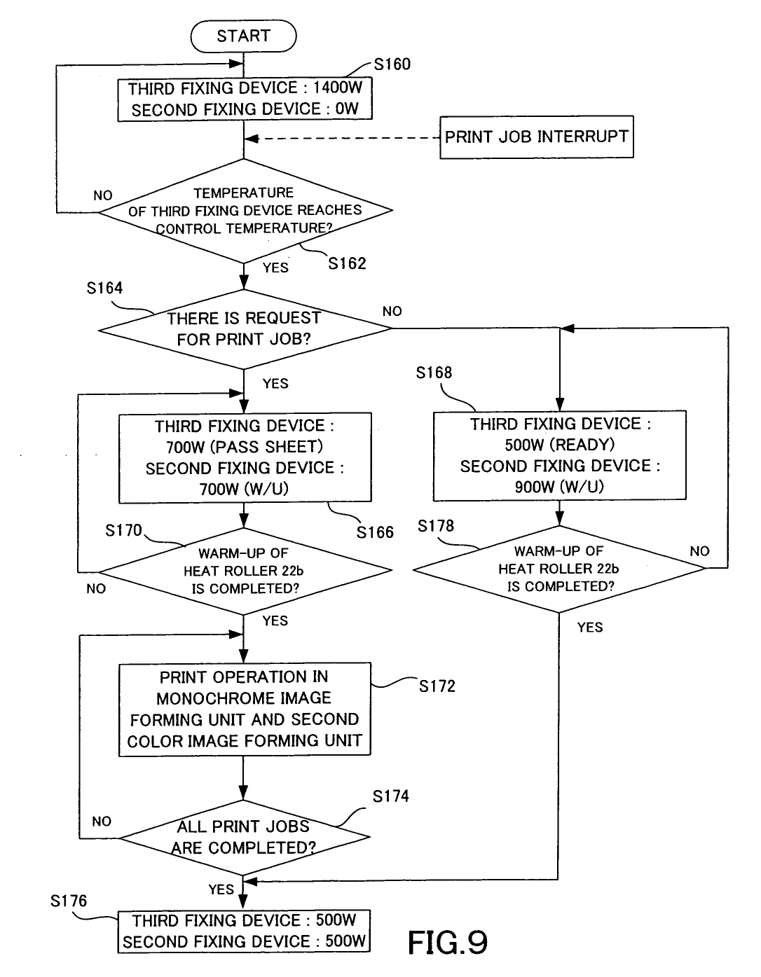

Actions will be described. At the time of warm-up, the control device 32 is initially set to warm up the third fixing device 131 first. Therefore, when a power supply of the image forming apparatus 150 is turned on, in accordance with a flowchart shown in FIG. 9, the control device 32 controls the inverter circuit 34 to supply electric power of 1400 W to the third fixing device 131 and set electric power supplied to the second fixing device 21 to 0 W (step 160). Since the heat roller of the third fixing device 131 has a thin core metal and no solid rubber layer, warm-up time is reduced to about 20 sec.

Subsequently, in step 162, when the control device 32 completes the warm-up of the third fixing device 131 (step 162), the control device 32 judges whether there is a request for a print job (step 164). If there is a request for a print job, the control device 32 proceeds to step 166. If there is no request for a print job, the control device 32 proceeds to step 168.

In step 166, the control device 32 carries out print operation in the third image forming unit 53. Subsequently, the control device 32 heats, presses, and fixes a monochrome toner image formed on the sheet P in the third fixing device 131. At this point, the control device 32 controls the inverter circuit 34 to supply electric power of 700 W to the third fixing device 131 in order to fix the monochrome toner image. At the same time, the control device 32 controls the inverter circuit 34 to supply electric power of 700 W to the second fixing device 21 in order to warm up the second fixing device 21.

When the control device 32 completes the warm-up of the heat roller 22b of the second fixing device 21 in step 170, the control device 32 proceeds to step 172, performs print operation for the monochrome image in both the third image forming unit 53 and the second image forming unit 2, and processes a print job at high speed. When the control device 32 completes all print jobs in step 172 (step 174), for preheat in the ready state, the control device controls the inverter circuit 34 to set electric power supplied to the third fixing device 131 and the second fixing device 21 to 500 W and stands by for the next print job (step 176).

On the other hand, in step 168, the control device 32 completes the warm-up of the third-fixing device 131 and controls the inverter circuit 34 to supply electric power of 500 W in order to preheat the third fixing device 131 in the ready state. At the same time, the control device 32 controls the inverter circuit 34 to supply electric power of 900 W to the second fixing device 21 in order to warm up the second fixing device 21. When the control device 32 completes the warm-up of the second fixing device 21 (step 178), the control device 32 controls the inverter circuit 34 to set electric power supplied to the third fixing device 131 and the second fixing device 21 to 500 W (step 176). In other words, the third fixing device 131 and the second fixing device 21 are preheated in the ready state and stand by for a request for a print job.

In this way, the control device 32 is initially set to warm up the third fixing device 131 first. Thus, it is possible to remarkably reduce standby time of the user at the time of warm-up. However, in the case of this initial setting, when there is a request for a color print job from the beginning, on the contrary, standby time of the user is extended more than necessary. Therefore, when a print job after completion of warm-up is a color print job from an advance input operation of the user (e.g., when an image read by the scanner unit 6 is printed in color or when color image data is already inputted as a print job), the image forming apparatus 150 warms up the second fixing device 21 first.

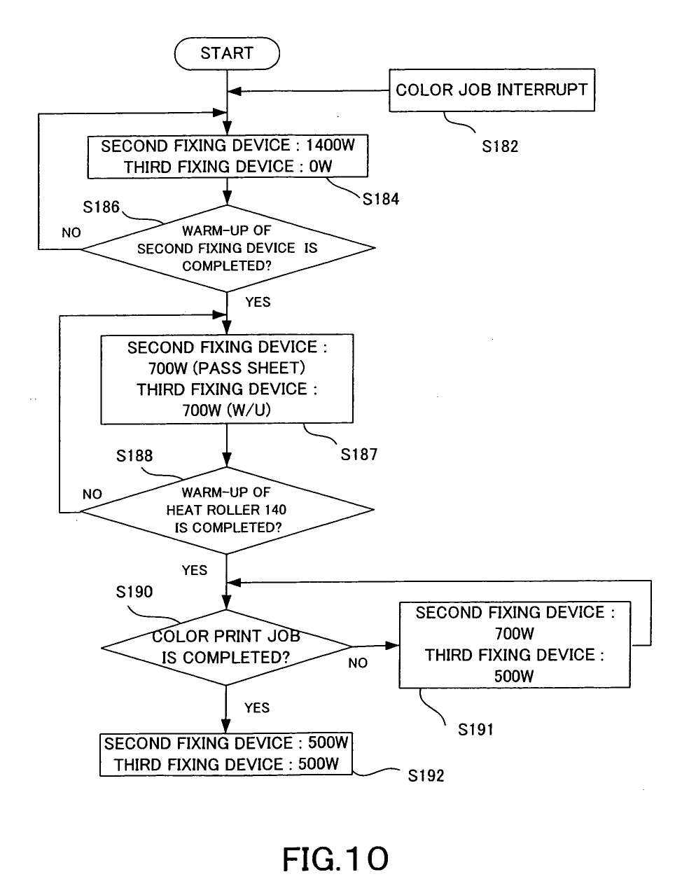

After turning on the power supply of the image forming apparatus 150, at a point when the control device 32 recognizes a request for a color print job, the control device 32 carries out warm-up of the second fixing device 21 first instead of the initial setting. For example, as shown in a flowchart in FIG. 10, when the power supply is turned on to start warm-up, if interruption of the color job is inputted from the CPU 33 (step 182), the control device 32 controls the inverter circuit 34 to supply electric power of 1400 W to the second fixing device 21 and set electric power supplied to the third fixing device 131 to 0 W (step 184).

Subsequently, when the control device 32 completes the warm-up of the second fixing device 21 in step 186, the control device 32 proceeds to step 187 and carries out print operation in the second image forming unit 2. The control device 32 heats, presses, and fixes a color toner image formed on the sheet P in the second fixing device 21. At this point, the control device 32 controls the inverter circuit 34 to supply electric power of 700 W to the second fixing device 21 in order to fix the color toner image. At the same time, the control device 32 controls the inverter circuit 34 to supply electric power of 700 W to the third fixing device 131 in order to warm up the third fixing device 131.

When the warm-up of the heat roller 140 of the third fixing device 131 in step 188 is completed, the control device 32 proceeds to step 190 and judges whether the control device 32 has completed the color print job. When the control device 32 has not completed the color print job, in step 191, the control device 32 reduces electric power supply only to the third fixing device 131 to 500 W for preheat in the ready state. When the control device 32 completes the color print job in step 190, the control device 32 proceeds to step 192, controls the inverter circuit 34 to set electric power supplied to the third fixing device 131 and the second fixing device 21 to 500 W for preheat in the ready state, and stands by for the next print jot.

The control device 32 judges which of the third fixing device 131 and the second fixing device 21 should be warmed up first according to content of a print job from the user and controls the inverter circuit 34. On the other hand, in warming up the remaining fixing devices, the control device 32 controls electric power supplied according to whether the fixing device, for which the warm-up is completed earlier, is performing fixing operation and carries out more effective warm-up. It is also possible to use the warm-up operation for the second fixing device 21 and the third fixing device 131 according to the flowcharts in FIGS. 9 and 10 in the control of the second fixing device 21 and the control of the third fixing device 131, for example, in restoring the image forming apparatus 150 from the off mode.

After the control device 32 completes the warm-up of the second fixing device 21 and the third fixing device 131, in step 192, when there is no request for a print job for a fixed time while the third fixing device 131 and the second fixing device 21 continue to be in the ready state, the control device 32 turns off the fixing device of the second image forming unit 2. Consequently, energy saving is realized while the control device 32 stands by for a print job. Thereafter, when a request for a print job is inputted, the control device 32 judges the job and controls the inverter circuit 34. In this energy saving, the second fixing device 21 may be brought into the ready state and, on the other hand, the third fixing device 131 may be turned off according to setting or the like by the user.

If content of the job is a monochrome job, the control device judges whether the second fixing device 21 should be turned on according to a print quantity. For example, if a print quantity of the print job is less than twenty-five, the control device 32 supplies electric power of 1400 W to the third fixing device 131 and, on the other hand, keeps electric power supplied to the second fixing device 21 at 0 W. If a print quantity is equal to or larger than twenty-five, the control device 32 controls the inverter circuit 34 to supply electric power of 700 W to the third fixing device 131 and supply electric power of 700 W to the second fixing device 21. In this way, the control device 32 processes print jobs in parallel using both the third image forming unit 53 and the second image forming unit 2.

If content of the job is a color job, the control device 32 controls the inverter circuit 34 to set electric power supplied to the third fixing device 131 to 0 W and, on the other hand, supply electric power of 1400 W to the second fixing device 21. When the control device 32 completes the warm-up of the second fixing device 21, the control device 32 carries out print operation in the second image forming unit 2 and, then, heats, presses, and fixes the color toner image formed on the sheet P in the second fixing device 21.

According to this embodiment, as in the first embodiment, the second image forming unit 2 and the third image forming unit 53 are set in parallel in the image forming apparatus 150 and, in processing print jobs, at the time of warm-up, one of the fixing devices 131 and 21 is started first to reduce time during which the user is on standby. At the time of monochrome print job processing, process speed of the jobs is increased using both third image forming unit 53 and the second image forming unit 2. Moreover, at the time of standby for a print job, one of the fixing devices 131 and 21 is turned off to realize energy saving. In other words, supply of electric power to the third fixing device 131 and the second fixing device 21 heated by the induction heating device 29 is controlled according to an operation state of the image forming apparatus 150. Therefore, even in the high-performance image forming apparatus 150 capable of processing a print job at high speed, it is possible to realize energy saving and improve convenience of use for the user.

A third embodiment of the invention will be explained. In the third embodiment, image forming units of an ink jet system are provided instead of the second image forming unit in the second embodiment and the image forming units are arranged serially. Moreover, a belt fixing device is used as a fixing unit. Otherwise, the third embodiment is the same as the second embodiment. Therefore, in the third embodiment, components identical with those explained in the second embodiment are denoted by the identical reference numerals and signs. Detailed explanations of the components are omitted.

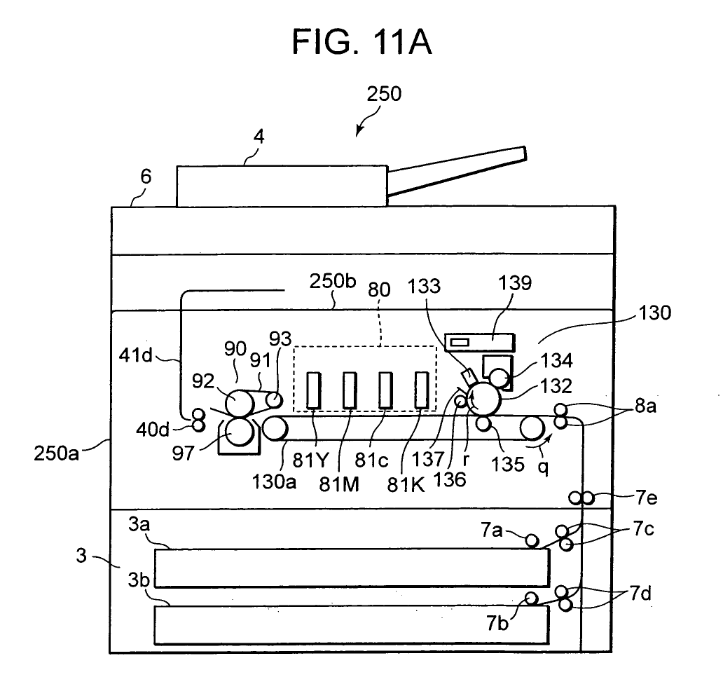

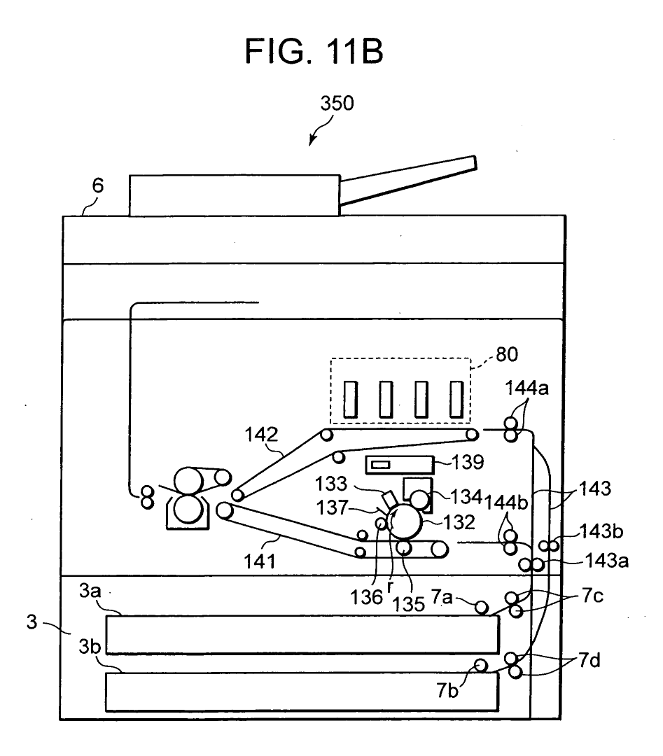

In the third embodiment, as shown in FIG. 11A, the monochrome image forming unit 130 and a fourth image forming unit 80 are provided along the transfer belt 130a in a main body 250a of an image forming apparatus 250. Downstream from the fourth image forming unit 80 of the image forming apparatus 250, a fifth fixing device 90 serving as a fixing unit is provided. Downstream from the fifth fixing device 90, a sheet discharge roller 40d is provided and a sheet discharge conveyance path 41d that conveys the sheet P after fixing to a sheet discharge unit 250b is provided.

The fourth image forming unit 80 is an image forming unit of the ink jet system. In the fourth image forming unit 80, ink jet heads 81K, 81C, 81M, and 81Y that discharge inks of respective colors of black (K), cyan (C), magenta (M), and yellow (Y) are arranged along the transfer belt 130a.

The ink jet head 81K of black (K) is a so-called full-line head in which nozzles are arranged over a width of 297 mm, which is a maximum recording width of the sheet P, at a pitch of, for example, 400 dpi. The respective ink jet heads 81C, 81M, and 81Y of cyan (C), magenta (M), and yellow (Y) have the same structure as the ink jet head 81k of black (K).

In the image forming apparatus 250, according to start of print operation, a monochrome toner image formed on the photosensitive drum 132 in the monochrome image forming unit 130 is transferred onto the sheet P in a position of the transfer roller 135. After the transfer, the sheet P is conveyed by the transfer belt 130a rotated in the arrow q direction. Respective ink images of black (K), cyan (C), magenta (M), and yellow (Y) are formed on the sheet P by the ink jet heads 81K, 81C, 81M, and 81Y in the fourth image forming unit 80. Thereafter, the sheet P passes the fifth fixing device 90 and the toner image is heated, pressed, and fixed, the ink image is dried and fixed, and a print image is completed on the sheet P. It is also possible to perform image formation on the sheet P by the image forming apparatus 250 only with the monochrome image forming unit 130 or the fourth image forming unit 80.

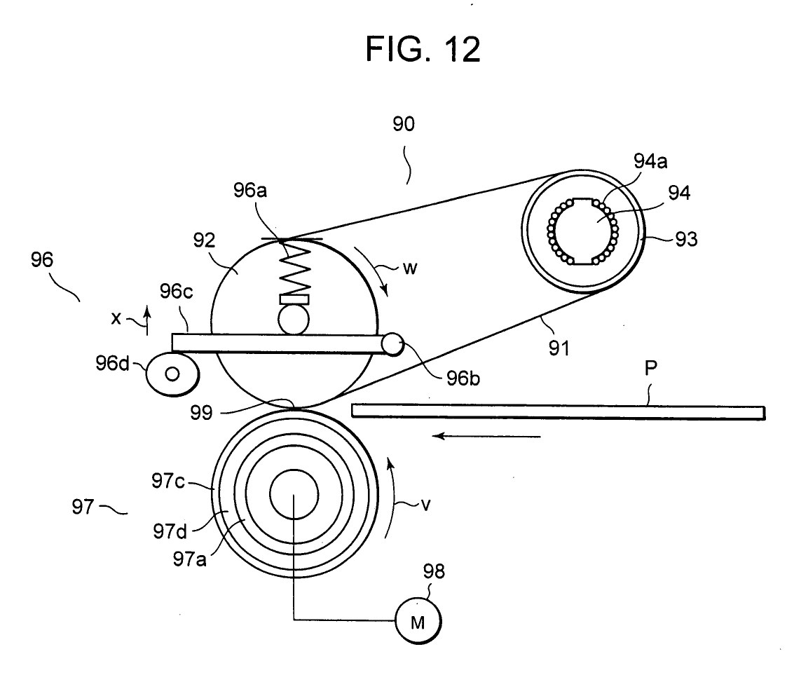

The fifth fixing device 90 will be described in detail. FIG. 12 is a schematic diagram showing the fifth fixing device 90. The fifth fixing device 90 is a belt fixing device that uses a fixing belt 91 with a diameter of 70 mm. The fixing belt 91 is a three-layer belt formed by coating, in thickness of 300 μm, silicon rubber having elasticity over the surface of a nickel (Ni) substrate with thickness of 40 μm and coating a release layer consisting of fluorine resin over the silicon rubber in thickness of 30 μm in order to give release properties to the belt. A base material of the fixing belt may be SUS, a material obtained by coating a metal layer over polyimide resin, or the like as long as the material has electrical conductivity.

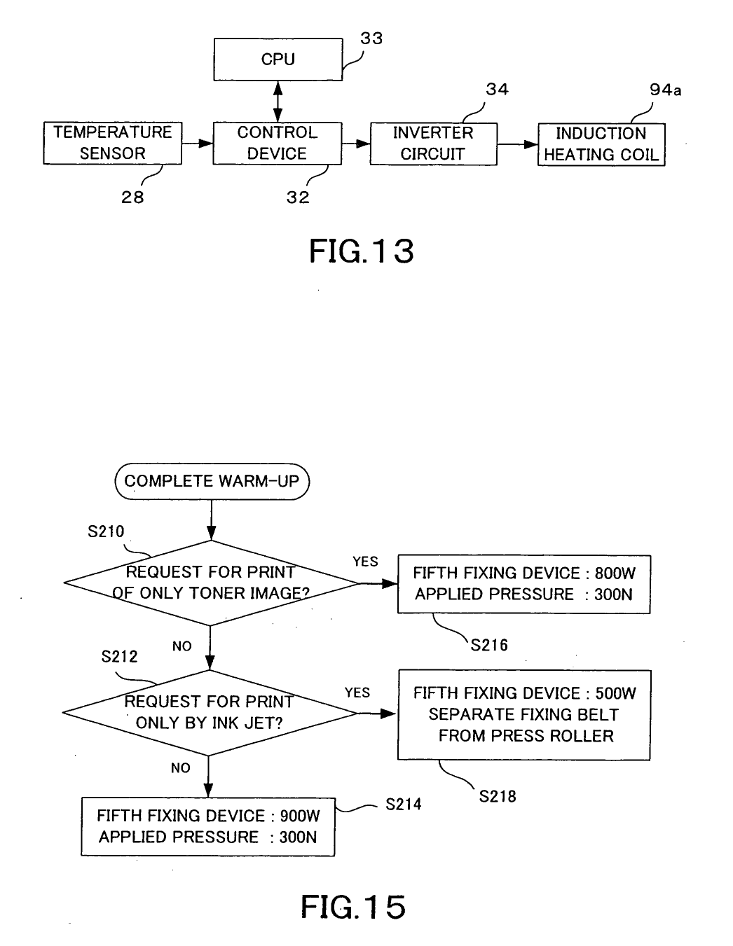

The fixing belt 91 is laid over with tension between a backup roller 92 and a heating roller 93. The backup roller 92 is a low thermal conductivity roller with a diameter of 30 mm consisting of, for example, silicon sponge foam having elasticity, the surface of which is low in hardness. The heating roller 93 has an induction heating device 94 in, for example, a roller of iron with thickness of 0.5 mm and a diameter of 20 mm. The heating roller 93 may be made of SUS430, SUS304, aluminum, or the like. The induction heating device 94 has an induction heating coil 94a. As shown in FIG. 13, the inverter circuit 34 supplies a high-frequency current to the induction heating coil 94a. It is possible to change a heating output of the inverter circuit 34 from 100 W to 1500 W by varying a driving frequency.

The fixing belt 91 and the backup roller 92 are brought into press contact with a press roller 97 by a pressing mechanism 96. The press roller 97 is driven in an arrow v direction by a driving motor 98. The fixing belt 91 and the backup roller 92 rotate in an arrow w direction following the press roller 97. The press roller 97 has a silicon rubber layer 97b and a release layer 97c around a core metal 97a and a diameter thereof is set to 30 mm.

The pressing mechanism 96 has a compression spring 96a that pushes the backup roller 92 in the direction of the press roller 97, a push-up bar 96c capable of rotating around a fulcrum 96b, and a push-up cam 96d that is rotated by the control device 32 and rotates the push-up bar 96c in an arrow x direction against a spring force of the compression spring 96a. The push-up cam 96d is rotated by the control device 32. The push-up bar 96c supports a shaft 92a of the backup roller 92.

The pressing mechanism 96 brings the fixing belt 91 and the backup roller 92 into press contact with the press roller 97 with a spring force of the compression spring 96a according to a rotation position of the push-up cam 96d to form a nip 99. If a load of the push-up cam 96d on the push-up cam bar 96c is 0, applied pressure of 150 N is applied on both the sides of the backup roller 92, respectively by the compression spring 96a (300 N in total).

Alternatively, the pressing mechanism 96 rotates the push-up bar 96c in the arrow x direction against the compression spring 96a and reduces a press contact force of the fixing belt 91 and the backup roller 92 against the press roller 97 generated by the compression spring 96a. Moreover, the pressing mechanism 96 rotates the push-up bar 96c in the arrow x direction against the compression spring 96a and makes it possible to separate the fixing belt 91 and the backup roller 92 from the press roller 97.

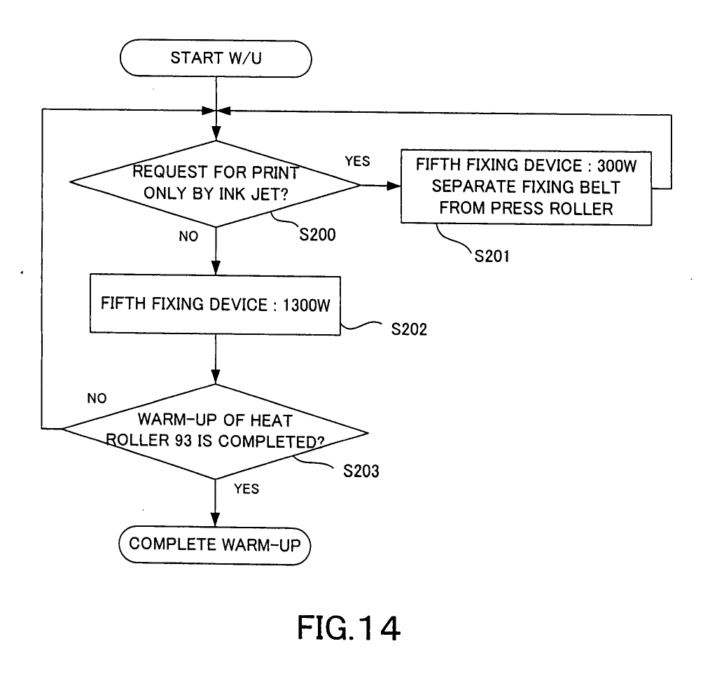

Actions will be described. At the time of warm-up, when a power supply of the image forming apparatus 250 is turned on, the control device 32 controls the fifth fixing device 90 in accordance with a flowchart shown in FIG. 14. In step 200, when a request for print only by ink jet is inputted from the CPU 33 in an advance input by a scanner, a print job, or the like, the image forming apparatus 250 starts ink jet printing by the fourth image forming unit 80 without waiting for completion of the warm-up of the fifth fixing device 90.

The control device 34 controls the inverter circuit 34 to supply electric power of 300 W to the induction heating coil 94a of the heating roller 93 of the fifth fixing device 90. At the same time, the control device 34 controls to rotate the push-up cam 96d of the pressing mechanism 96. Consequently, the push-up cam 96d rotates the push-up bar 96c in the arrow x direction against the compression spring 96a to separate the fixing belt 91 and the backup roller 92 from the press roller 97 (step 201). The image forming apparatus 250 immediately starts ink jet printing by the fourth image forming unit 80 in this state. Thus, the user does not feel stress of being kept waiting for print at the beginning of a print job.

In the case of the request for print only by ink jet, supply of electric power to the induction heating coil 94a may be 0 W. Moreover, the push-up bar 96c may be rotated in the arrow x direction to reduce a press contact force of the fixing belt 91 and the backup roller 92 against the press roller 97. As the push-up bar 96c is rotated in the arrow x direction, applied pressure of the backup roller 92 on the press roller 97 is gradually reduced from 300 N against a pressing force of the compression spring 96a.

In general, when print is performed by ink jet, an ink penetrates the sheet P according to the capillary action at a point when the ink is ejected on the sheet P. Therefore, the sheet P having an image printed thereon by ink jet does not require thermal energy for melting a toner into the sheet P by applying pressure to the toner as at the time when a toner image is fixed. Regardless of such a state, when high temperature and high pressure are applied at the time of fixing of the print by ink jet, it is likely that a paper wrinkle or paper curl is caused in the sheet P.

Since there are a place where liquid ink is applied and a place where the liquid ink is not applied are present in the sheet Phavingan image printed by ink jet, a moisture absorption state is different depending on a place. When the sheet P passes between the fixing belt 91 and the press roller 97 under high temperature and high pressure in this state, it is likely that a paper wrinkle or paper curl is caused in the sheet P. However, as in step 201, if the fixing belt 91 and the press roller 97 are separated to reduce the temperature of the fixing belt 91, it is possible to prevent sudden drying and prevent a paper wrinkle or paper curl from being caused.

Since the fixing belt 91 and the press roller 97 are close to each other, even at the time of continuous print at high speed, drying characteristics of an ink jet image are not spoiled by radiation heat from the fixing belt 91. Therefore, it is possible to cope with high process speed and obtain a satisfactory ink jet image.

In step 200, when there is no request for print only by ink jet, the control device 32 controls the inverter circuit 34 to supply electric power of 1300 W to the fifth fixing device 90 (step 202). In step 203, when the temperature of the heat roller 93 of the fifth fixing device 90 reaches 180° C., the control device 32 completes the warm-up. Since electric power as large as 1300 W is supplied to the fifth fixing device 90, warm-up time is reduced to about 30 sec.

Control in performing fixing at the time of print after the completion of the warm-up of the fifth fixing device 90 will be described. The control device 32 controls the fifth fixing device 90 in three modes corresponding to image formation patterns in accordance with a flowchart shown in FIG. 15. When the warm-up of the fifth fixing device 90 is completed and the fifth fixing device 90 is in the ready state, electric power of 500 W is supplied to the fifth fixing device 90 by the inverter circuit 34 for preheat to keep the ready state.

(Mode 1: Print only a Toner Image) At the ready time, the control device 32 judges whether a request for a print job inputted from the CPU 33 is print of only a toner image (step 210). If the request is print of only a toner image formed by the monochrome image forming unit 130, the control device 32 controls the inverter circuit 34 to supply electric power of 800 W to the induction heating coil 94a of the heating roller 93 (step 46). At the same time, the control device 34 controls the push-up cam 96d to reduce loads on the push-up cam bar 96c to 0. Consequently, the temperature of the fixing belt 90 in the nip portion 99 is raised to 160° C. Applied pressure of 300 N is applied to the backup roller 92 by the compression spring 96a. Therefore, A toner image on the sheet P is sufficiently heated, pressed, and fixed while the sheet P passes the nip 99 of the fifth fixing device 90 and satisfactorily fixed.

(Mode 2: Print only an Ink Jet Image)

At the ready time, the control device 32 judges whether a request for a print job inputted from the CPU 33 is print of only an ink jet image (step 212). If the request is print of only an ink jet image by the fourth image forming unit 80, the control device 32 controls the inverter circuit 34 to supply electric power of 500 W to the induction heating coil 94a of the heating roller 93. At the same time, the control device 34 controls to rotate the push-up cam 96d of the pressing mechanism 96. Consequently, the push-up cam 96d rotates the push-up bar 96c in the arrow x direction against the compression spring 96a to separate the fixing belt 91 and the backup roller 92 from the press roller 97 (step 218). Therefore, as described above, a paper wrinkle or paper curl is not caused in the sheet P at the time of fixing in the print by ink jet. Even at the time of continuous print at high speed, drying characteristics are not spoiled and a satisfactory ink jet image is obtained.

(Mode 3: Print both a Toner Image and an Ink Jet Image)

At the ready time, if a request for a print job inputted from the CPU 33 is print of both a toner image and an ink jet image (print images on the sheet P using both the monochrome image forming unit 130 and the fourth image forming unit 80) (NO in step 212) , the control device 32 proceeds to step 214. In step 214, the control device 32 controls the inverter circuit 34 to supply electric power of 900 W to the induction heating coil 94a of the heating roller 93. At the same time, the control device 34 controls the push-up cam 96d to reduce loads on the push-up cam bar 96c to 0.

Consequently, compared with the time of print of only a toner image, the temperature of the fixing belt 90 of the nip portion 99 rises by 10° C. to 170° C. Applied pressure of 300 N is applied to the backup roller 92 by the compression spring 96a. In general, when both a toner image and an ink jet image are formed on the sheet P, since ink of the ink jet image adheres to the sheet P, a thermal capacity of the entire image is increased. However, since the temperature of the fixing belt 90 is raised to 170° C., even at the time of continuous print, temperature drop does not occur, sufficient thermal energy is obtained, the toner image is heated, pressed, and fixed sufficiently, and a satisfactory fixed image is obtained.

According to this embodiment, the monochrome image forming unit 130 and the fourth image forming unit 80 are set serially in the image forming apparatus 250 and, if a request for a print job is a request for print only by ink jet, a print job is started without waiting for completion of warm-up of the fifth fixing device 90. Therefore, the user does not feel stress of being kept waiting for print at the beginning of the print job. If a request for a print job is a request for print only by ink jet, the temperature of the fixing belt 91 is raised to 160° C. and applied pressure of the backup roller 92 on the press roller 97 is reduced to 0. Therefore, since it is unlikely that a paper wrinkle or paper curl is caused in the sheet P, a satisfactory image is obtained.

Moreover, at the time of print, the control device 32 controls the fifth fixing device 90 in a mode corresponding to an image formation pattern. Therefore, in the image forming apparatus 250, a paper wrinkle or paper curl is not caused in the sheet P and it is possible to sufficiently heat and press a toner image in all of (mode 1: print only a toner image), (mode 2: print only an ink jet image), and (mode 3: print both a toner image and an ink jet image). As a result, a high-quality image is obtained in all the modes.

As shown in a modification in FIG. 11B, the monochrome image forming unit 130 of the electrophotographic system and the image forming unit 80 of the ink jet system may be arranged in parallel in a main body 350a of an image forming apparatus 350. In this image forming apparatus 350, the monochrome image forming unit 130 arranged along a transfer belt 141 is used at the time when monochrome print is requested. The fourth image forming unit 80 arranged along a conveyor belt 142 is used at the time when color print is requested. The fifth fixing device 90 is provided downstream from the monochrome image forming unit 130 and the fourth image forming unit 80. Reference numeral 143 denotes a conveyance path; 143a and 143b, conveying rollers; 144a and 144b, pickup rollers.

In this modification, at the time of image formation by the monochrome image forming unit 130, the fifth fixing device 90 is controlled as in the (mode 1) described above. At the time of image formation by the fourth image forming unit 80, the fifth fixing device 90 is controlled as in the (mode 2) described above. However, when there is a monochrome print request at the time of warm-up, a monochrome image is formed using the fourth image forming unit 80 of the ink jet system during a period until the temperature of the fifth fixing device 90 reaches a toner fixable temperature.

Thereafter, when the warm-up of the fifth fixing device 90 is completed, image formation is switched to monochrome print by the monochrome image forming unit 130 of the electrophotographic system. Consequently, the user does not feel stress of being kept waiting for print at the beginning of a print job.

The invention is not limited to the embodiments described above. Various modifications are possible within the scope of the invention. For example, the number, a structure, or the like of the plural image forming units built in the same housing is not limited. For example, in the image forming apparatus according to the second embodiment, an image forming unit of the ink jet system may be further built in other than the monochrome and color image forming units and made drivable simultaneously. The fixing unit may be an arbitrary unit such as a fixing roller or a fixing belt. Moreover, details of control such as a magnitude of an electric current supplied to the respective fixing units and a magnitude of applied pressure on the fixing units at the warm-up time or the ready time are not limited and are arbitrarily decided according to driving operations required by the respective image forming apparatuses.

1. An image forming apparatus comprising:
plural image forming units that are built in a same housing and can be driven simultaneously, at least one of which includes an electrophotographic system;
plural fixing units configured to fix images formed by the image forming units on recording media; and
a control unit configured to variably control warm-up operations for the plural fixing units in accordance with driving operations for the plural image forming units.

2. An image forming apparatus according to claim 1, wherein the control unit controls the warm-up operations for the plural fixing units according to content of advance input processing or content of jobs of the plural image forming units.

3. An image forming apparatus according to claim 1, wherein the control unit controls, after completing warm-up of one of the plural fixing units, the warm-up operations for the remaining fixing units.

4. An image forming apparatus according to claim 1, wherein the control unit preheats only one of the fixing units at ready time of the plural fixing units.

5. An image forming apparatus according to claim 4, wherein the control unit preheats the one of the fixing units according to a residual amount of toner or a number of prints of the plural image forming units.

6. An image forming apparatus according to claim 1, wherein the plural image forming units are detachably attachable to the housing, respectively.

7. An image forming apparatus according to claim 1, wherein the at least one image forming unit of the electrophotographic system has an image bearing member and process members acting on the image bearing member, and
the image bearing member and the at least one of the process members constitute a process cartridge integrally detachably attachable to the housing.

8. An image forming apparatus comprising:
plural image forming units configured to include an image forming unit of an electrophotographic system and an image forming unit of an ink jet recording system and are built in a same housing;
a fixing unit configured to be located on a conveyance path for a first recording medium having an image formed by the image forming unit of the ink jet recording system and heat, press, and fix an image formed by at least the image forming unit of the electrophotographic system on a second recording medium; and
a control unit configured to make it possible to vary or release applied pressure of the fixing unit at the time of driving of at least the image forming unit of the ink jet recording system.

9. An image forming apparatus according to claim 8, wherein the control unit controls fixing temperature of the fixing unit and, when the first recording medium and the second recording medium are the same, controls fixing temperature of the fixing unit according to fixing characteristics of an image formed by the image forming unit of the electrophotographic system.

10. An image forming apparatus according to claim 8, wherein the control unit variably controls a warm-up operation for the fixing unit in accordance with driving operations for the plural image forming units and, when advance input processing at warm-up time is a driving operation by the image forming unit of the ink jet recording system, starts the driving operation by the image forming unit of the ink jet recording system before completion of warm-up of the fixing unit by the control unit.

11. An image forming apparatus according to claim 8, wherein the plural image forming units are detachably attachable to the housing, respectively.

12. An image forming apparatus according to claim 8, wherein the at least one image forming unit of the electrophotographic system has an image bearing member and process members acting on the image bearing member, and
the image bearing member and the at least one of the process members constitute a process cartridge integrally detachably attachable to the housing.

13. An image forming apparatus according to claim 8, wherein either serial paths or parallel paths are selectable as the conveyance path for the first recording medium and a conveyance path for the second recording medium.

14. A warm-up method for an image forming apparatus having plural fixing units that fix images formed by plural image forming units, which are built in a same housing, include an electrophotographic system, and can be driven simultaneously, on a recording medium, the warm-up method comprising:
detecting content of advance input processing or content of jobs of the plural image forming units; and
variably performing warm-up operations for the plural fixing units in accordance with a result of the detection.

15. A warm-up method for an image forming apparatus according to claim 14, wherein, after warm-up of one of the plural fixing units is completed, the warm-up operations for the remaining fixing units are performed.

16. A warm-up method for an image forming apparatus according to claim 14, wherein, if the plural fixing units are in a ready state, only one of the fixing units is preheated.

17. A warm-up method for an image forming apparatus according to claim 16, wherein the one of the fixing units is preheated according to a residual amount of toner or a number of prints of the plural image forming units.

18. An image forming method for an image forming unit having a fixing unit that heats, presses, and fixes, on a second recording medium, an image formed by an image forming unit of an electrophotographic system that is built in a same housing and located on a conveyance path for a first recording medium by an image forming unit of an ink jet recording system and can be driven simultaneously with the image forming unit of the ink jet recording system, the image forming method comprising:
making it possible to vary or release applied pressure of the fixing unit at the time of a driving operation for the image forming unit of the ink jet recording system.

19. An image forming method for an image forming apparatus according to claim 18, wherein, when the first recording medium and the second recording medium are the same, fixing temperature of the fixing unit is controlled according to fixing characteristics of an image formed by the image forming unit of the electrophotographic system.

20. An image forming method for an image forming apparatus according to claim 18, wherein, when advance input processing at start-up time is a driving operation by the image forming unit of the ink jet recording system, the driving operation by the image forming unit of the ink jet recording system is started before completion of warm-up of the fixing unit.
